(19) United States
(12) Patent Application Publication
(10) Pub. No.: US 2014/0008278 A1
(43) Pub. Date: Jan. 9, 2014

(54) OIL-WATER SEPARATOR

(71) Applicants: HASSAN MOHAMED BADR, DHAHRAN (SA); WAEL HASAN AHMED, DHAHRAN (SA)

(72) Inventors: HASSAN MOHAMED BADR, DHAHRAN (SA); WAEL HASAN AHMED, DHAHRAN (SA)

(73) Assignee: KING FAHD UNIVERSITY OF PETROLEUM AND MINERALS, DHAHRAN (SA)

(21) Appl. No.: 13/544,623

(22) Filed: Jul. 9, 2012

(51) Int. Cl. C02F 1/40

(52) U.S. Cl. 210/96.1; 210/512.1

(57) ABSTRACT

The oil-water separator is installed in a substantially horizontal crude oil pipeline for separating water from the oil and water mix. The separator includes a vortex and settling chamber extending downward from the pipeline. The segment of the pipeline having the separator defines a generally T-shaped configuration. Oil and water phases flowing through the pipeline drop into the chamber as it flows through the pipeline and over the chamber. The denser water tends to settle into the bottom of the chamber, while the lighter oil is entrained back into the flow through the pipeline. A sensor detects water collected in the bottom of the chamber and provides a signal to open a drain valve when sufficient water has been collected. While only a single separator serves to collect a substantial fraction of water, a series of separators may be installed along the pipe to remove more water from the oil.

### BACKGROUND OF THE INVENTION

1. Field of the Invention

The present invention relates to devices for separating dissimilar fluids from one another, and particularly to an oil-water separator comprising a vortex or swirl chamber depending from a delivery pipe.

2. Description of the Related Art

Virtually all output from oil wells comprises a mixture of three phases of material, i.e., solid particulates in the form of sand and the like, a liquid mix of crude oil and water, and gas or gases, primarily methane and carbon dioxide. (It should be noted here that in the petroleum industry, the term “phase” is used to describe a single type of liquid issuing from a well, i.e., oil and water are referred to as a liquid comprising an oil phase and a water phase.) The solids and gas are relatively easy to separate from the liquid fraction of the well output, as they comprise two separate physical phases. It is somewhat more difficult, and generally requires more energy, to separate materials belonging to a single physical phase (e.g., methane and carbon dioxide gas phase mix, or oil and water liquid phase mix) from one another. Thus, it is impractical to separate oil and water from one another at a remote wellhead, given the present state of the art.

Accordingly, while gases and solid particulates are generally separated from the liquid phase at or near the wellhead in the petroleum field, the liquid phase (comprising a mixture of oil and water) is commonly transported via pipeline over some distance to a central refinery or processing plant, where they are separated. The pumping of an oil and water mix through a pipeline demands relatively large amounts of energy due to relatively high pressure drops in the line resulting from the oil and water mix. In any event, the movement of the mass of the water fraction through the pipeline requires additional energy over and above that required to move only the oil fraction of the mix. The alternative is to provide a settling pool or the like near the wellhead where the denser water will settle out beneath the lighter oil. However, the additional time that this requires is also impractical.

Thus, an oil-water separator solving the aforementioned problems is desired.

### SUMMARY OF THE INVENTION

The oil-water separator comprises a generally horizontal length of pipe having an inlet end and an opposite outlet end, and a vortex and settling chamber extending below the pipe. As the water and oil mixture encounters the chamber, it drops into the chamber. The dynamic energy of the water and oil mix is dissipated in the chamber in the form of turbulence and eddies. The denser water settles out of the lighter oil due to the force of gravity as their velocities slow. The lighter oil, being nearer the upper end of the chamber, is entrained into the moving horizontal stream of oil and any remaining water passing over the vortex and settling chamber. This configuration requires little more power than that required to pump the oil and water mix through the pipeline, and actually results in a net reduction of required power due to the removal of the water from the liquid phase mix.

The relative quantities of water and oil in the chamber may be determined by a conventional capacitance sensor or other conventional means. The output of the sensor is used to control a drain valve at the bottom of the chamber to release the collected water when it is determined that the water collected in the bottom of the chamber is substantially free of oil. The water may be dispensed as a waste product, or may be used for other purposes, with or without some additional processing. In any event, any additional processing required to gain the water purity required for the desired use will be much easier to attain and will be much less energy intensive due to the initial removal of the greater majority of the oil by the vortex and settling chamber.

Although a substantial amount of water can be removed from the oil passing through the pipeline by means of a single vortex and settling chamber, it will be seen that the installation of two or more such chambers spaced along the length of the pipeline will result in additional incremental amounts of water being removed from the oil as it travels through the pipeline. As the vortex and settling chambers are relatively economical to install and operate, any number of such chambers may be installed along a length of pipeline in accordance with the degree of purification of the oil desired. The removal of the greater majority of the water from the oil has further benefits in that it not only reduces the energy required to pump the liquid through the pipeline, but it also reduces corrosion in the pipeline and other components (e.g., pumps, valves, etc.) by removal of the water.

These and other features of the present invention will become readily apparent upon further review of the following specification and drawings.

### BRIEF DESCRIPTION OF THE DRAWINGS

FIG. 1 is a schematic side elevation view of a pipeline having a single oil-water separator according to the present invention disposed therein, illustrating its configuration.

FIG. 2 is a schematic side elevation view of a pipeline having a plurality of oil-water separators according to the present invention disposed therein for multi-stage phase separation in a single pipeline.

Similar reference characters denote corresponding features consistently throughout the attached drawings.

### DETAILED DESCRIPTION OF THE PREFERRED EMBODIMENTS

The oil-water separator is a passive unit that serves to separate entrained water from crude oil being transported through a delivery pipeline. The device does not require any electrical or other power for its basic operation, other than for the operation of a low powered sensor and the periodic operation of a water drain valve, and produces only a minimal pressure drop in the pipeline. The device is thus well suited for remote installation at or near a wellhead to separate the crude oil fraction from the oil and water liquid issuing from the wellhead, thereby providing greater economy in the transport of the crude oil.

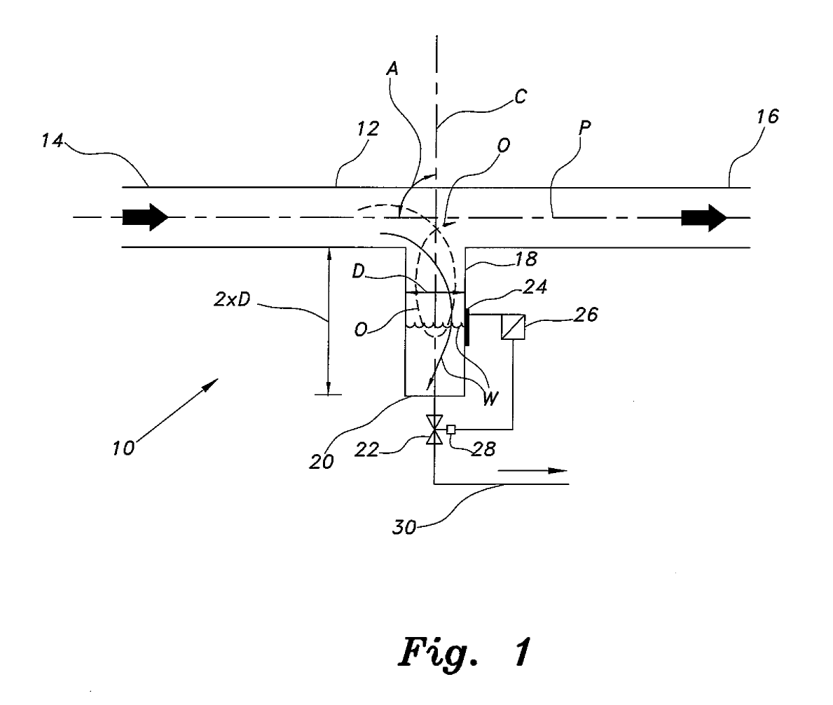

FIG. 1 of the drawings provides a schematic elevation view of pipeline having an exemplary single oil-water separator 10 disposed therein. The separator 10 includes an elongate, substantially horizontal pipeline 12 having an inlet end 14 and an opposite outlet end 16. It will be seen that the pipeline 12 may extend for some distance. The inlet and outlet ends 14 and 16 depicted in the drawings indicate only an inflow or upstream end and an opposite outflow or downstream end that would be connected in a much longer pipeline.

The pipeline 12 has a vortex and settling chamber 18 depending therebelow, which may be formed by inserting a Tee Connector in the pipeline 12. The internal volume of the chamber 18 communicates with the internal volume of the pipeline 12. The longitudinal axis P of the pipeline 12 and the longitudinal axis C of the chamber 18 preferably form a right angle A, i.e., the chamber 18 is normal to the pipeline 12 to form a substantially T-shaped configuration for the pipeline 12 and chamber 18 assembly. However, the chamber 18 may be installed to the pipeline 12 with some other angle therebetween, if desired.

The vortex and settling chamber 18 has a substantially closed bottom end 20, with the exception of a selectively operable water drain valve 22 installed therein and discussed further below, The height or vertical depth of the chamber 18 may be adjusted as desired, depending upon the rate of flow of liquid through the pipeline 12, the width or diameter of the chamber 18 and pipeline 12, and other factors. In the exemplary separator 10 depicted in FIG. 1, the vortex and settling chamber 18 has a width or diameter D, and a vertical depth or height of 2×D, i.e., somewhat more than twice the diameter D.

The oil and water separator 10 operates automatically to collect water in the vortex and settling chamber 18 as the mixture or slurry of crude oil and water flows through the pipeline 12. As the oil and water mix encounters the side arm of the Tee forming the chamber 18, the discontinuity of the open mouth of the chamber 18 in the main pipe 12 produces a turbulent swirl or vortex within the chamber 18. As water is more dense than oil, the denser water W will tend to flow to the outside of the vortex, i.e., closer to the bottom of the chamber 18 at the lower portion of the vortex. The lighter oil O will tend to rise, where it is again entrained by the oil and water mixture flowing through the pipeline 12. Thus, there are two physical principles in play to separate the water from the oil, i.e., the formation of a vortex within the chamber 18, and gravity acting on the denser water to cause it to settle to the lower portion of the chamber 18.

As the oil and water slurry or liquid flows through the pipeline 18 and over and into the vortex and settling chamber 18, water will collect in the lower portion of the chamber 18. Accordingly, some means must be provided for periodically draining any water that collects in the vortex and settling chamber 18. This is accomplished by an oil-water fraction sensor 24 that is disposed in the interior of the chamber 18, or at least communicates with the interior of the chamber 18. The sensor 24 is preferably a conventional capacitance-type sensor, but other sensors using other principles of operation may be used. As the output of the sensor 24 is an analog signal, an analog-to-digital electronic converter 26 communicates electronically with the sensor 24 and sends a signal to the drain valve controller 28 (e.g., a microcontroller circuit, digital signal processor circuit, etc.), The drain valve controller 28 controls the drain valve 22 (which may be a normally closed solenoid valve that can be opened and closed by applying the appropriate voltage or current to the coil) to open when the water collected in the bottom of the vortex and the settling chamber 18 is determined to be substantially free of oil, in response to the signal from the sensor 24. When some predetermined fraction of oil is detected, the sensor 24 provides a corresponding signal and the controller 28 closes the water drain valve 22. The water drained from the drain valve 22 may be dispensed at the point of drainage, if it is sufficiently clean and no other environmental concerns exist. However, water is a somewhat valuable commodity in many oil production locales, and the water drained from the chamber 18 may be collected for further use or processing by a water collection and delivery line 30 extending from the valve 22, if desired.

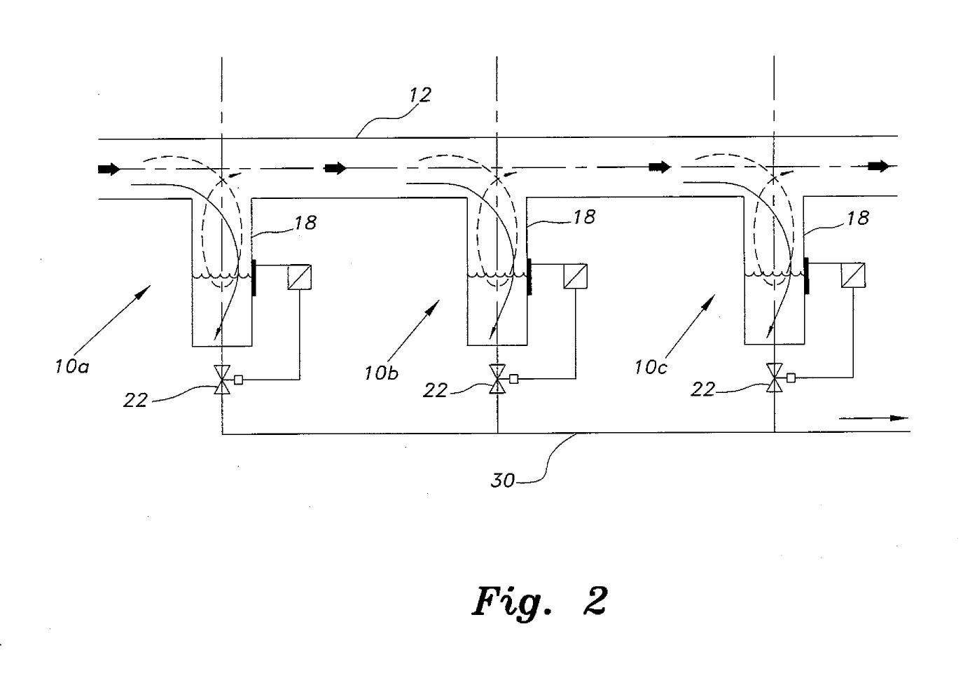

The oil-water separator 10, when configured in a single stage as shown in FIG. 1, may not be able provide one hundred percent separation of the oil and water fractions typically found in the crude oil flowing through a pipeline. However, it does remove a large fraction of the water typically mixed with the crude oil as delivered from the well. Nevertheless, in many instances the removal of a larger fraction of the water from the oil may be desired. Accordingly, an oil-water separator system comprising a series of mutually spaced apart vortex and settling chambers 18 installed along a pipeline 12 is illustrated schematically in FIG. 2 of the drawings, which shows three chambers 18 and the corresponding portions of the pipeline 12 comprising a plurality of oil-water separators 10a, 10b, and 10c. Each of the oil-water separators 10a, 10b, and 10c of FIG. 2 is substantially identical to the oil-water separator 10 of FIG. 1, discussed in detail further above. Accordingly, no further discussion of the structure and details of operation of the oil-water separators 10a through 10c need be provided here. The advantage of the plurality of oil-water separators 10a through 10c is that the second separator 10b will remove a large part of any remaining water that passes by the first separator 10a, with the third separator 10c removing a large part of the small fraction of water that still remains after passing the second separator 10b. The illustration of FIG. 2 showing three such oil-water separators 10a through 10c is exemplary. It will be seen that any practicable number of such separators may be installed along a pipeline 12 to form a multi-stage separator, resulting in the removal of more of the water fraction from the oil and water mix or slurry flowing through the pipeline 12. The water collected in each vortex and settling chamber 18 may be drained into the environment, or collected and transported to another location for further use, purification, disposal, etc. by a common water collection and delivery line 30 that is connected to each of the drain valves 22 of the chambers 18.

It is to be understood that the present invention is not limited to the embodiments described above, but encompasses any and all embodiments within the scope of the following claims.

1. An oil-water separator, comprising:
an elongate, level pipeline having an inlet end for receiving an oil-water mixture and an outlet end opposite the inlet end and being in line, coaxial and integral therewith the outlet end outputting oil separated from the oil-water mixture; and
at least one combined vortex and settling chamber depending below the pipeline, the pipeline and the combined vortex and settling chamber forming a T-shaped configuration, wherein the at least one combined vortex and settling chamber has an open upper end in fluid communication with said elongate, level pipeline such that the oil-water mixture entering the at least one combined vortex and settling chamber is separated into oil and water, the oil having a density less than that of the water such that the water remains within the at least one combined vortex and settling chamber as the oil exits through the open upper end, back into the elongate, level pipeline.

2. The oil-water separator according to claim 1, further comprising:
the combined vortex and settling chamber having a bottom; and
a water drain valve disposed at the bottom of the combined vortex and settling chamber.

3. The oil-water separator according to claim 2, further comprising an oil-water fraction sensor disposed in the combined vortex and settling chamber.

4. The oil-water separator according to claim 3, wherein:
the oil-water fraction sensor is a capacitance sensor; and
an analog to digital electronic control communicates electronically with the capacitance sensor and the water drain valve, the analog to digital electronic control selectively sending electronic signals to the water drain valve to control the opening and closing thereof in accordance with electronic signals received from the capacitance sensor.

5. The oil-water separator according to claim 1, further comprising a plurality of mutually spaced apart combined vortex and settling chambers depending below the pipeline.

6. The oil-water separator according to claim 1, wherein the combined vortex and settling chamber is normal to the pipeline.

7. The oil-water separator according to claim 1, wherein the combined vortex and settling chamber has a width and a depth, the depth being at least twice the width.

8-14. (canceled)

15. An oil-water separator, comprising:
an elongate, level pipeline having an inlet end for receiving an oil-water mixture and an outlet end opposite the inlet end and being in line, coaxial and integral therewith, the outlet end outputting oil separated from the oil-water mixture; and
a plurality of mutually spaced apart combined vortex and settling chambers depending below the pipeline, the pipeline and each of the combined vortex and settling chambers forming a T-shaped configuration, wherein each said combined vortex and settling chamber has an open upper end in fluid communication with said elongate, level pipeline such that the oil-water mixture entering each said combined vortex and settling chamber is separated into oil and water, the oil having a density less than that of the water such that the water remains within the combined vortex and settling chamber as the oil exits through the open upper end, back into the elongate, level pipeline.

16. (canceled)

17. The oil-water separator according to claim 15, further comprising:
each of the combined vortex and settling chambers having a bottom; and
a water drain valve disposed at the bottom of each of the combined vortex and settling chambers.

18. The oil-water separator according to claim 17, further comprising an oil-water fraction sensor disposed in each of the combined vortex and settling chambers.

19. The oil-water separator according to claim 18, wherein:
the oil-water fraction sensor is a capacitance sensor; and
an analog to digital electronic control communicates electronically with the capacitance sensor and the water drain valve, the analog to digital electronic control selectively sending electronic signals to the water drain valve to control the opening and closing thereof in accordance with electronic signals received from the capacitance sensor.

20. The oil-water separator according to claim 15, wherein:
each of the vortex and settling chambers is normal to the pipeline; and
each of the vortex and settling chambers has a width and a depth, the depth being at least twice the width.
